(19) United States
(12) Patent Application Publication
(10) Pub. No.: US 2008/0226426 A1
(43) Pub. Date: Sep. 18, 2008

(54) Punch/binding machine and binding module thereof

(75) Inventors: Li-Ming Cheng, Kaohsiung City (TW); Kue-Lin Tsai, Kaohsiung City (TW); Shi-Mo Liaw, Kaohsiung City (TW)

Correspondence Address: SUGHRUE MION, PLLC, 2100 PENNSYLVANIA AVENUE, N.W., SUITE 800, WASHINGTON, DC, 20037, US

(73) Assignee: ZIPSHADE INDUSTRIAL (B.V.I.) CORP., Tortola (VG)

(21) Appl. No.: 11/716,716

(22) Filed: Mar. 12, 2007

(51) Int. Cl. B42B 9/00

(52) U.S. Cl. 412/40

(57) ABSTRACT

The present invention relates to a punch/binding machine and a binding module thereof. The punch/binding machine includes a transmission device, a body, and a binding module. The transmission device receives an external force. The body is used to support the transmission device. The binding module includes a fixing rod, a fixed comb plate, an upper board, a guide element, a moving seat, and a lower board. Two ends of the fixing rod are fixed on the body. The fixed comb plate has a plurality of fixing combs, and each of the fixing combs has a flute. The upper board has a plurality of slot apertures for the fixing combs to pass through. The guide element is located on one side of the upper board in order to push a plastic comb into the flutes of the fixing combs. The moving seat has a plurality of shifting rods for pulling the plastic comb. At least one end of the moving seat is connected to the transmission device, so as to be driven by the transmission device. The lower board is located below the moving seat for providing the moving seat to slide on the surface thereof. Thereby, the binding module is formed by stacking three plates, which has a small number of components and is easily assembled.

### BACKGROUND OF THE INVENTION

1. Field of the Invention

The present invention relates to a punch/binding machine, and more particularly to a punch/binding machine for loose-leaf papers and a binding module thereof.

2. Description of the Related Art

FIGS. 1 and 2 show a schematic assembly view and a schematic exploded view of a first-type binding mechanism of a conventional punch/binding machine for loose-leaf papers disclosed in U.S. Pat. No. 5,211,522. The conventional first-type binding mechanism 1 is used to pull a plastic comb 2 (FIG. 3). The conventional first-type binding mechanism 1 includes a binding module 10 and a transmission device 18. The binding module 10 includes a pushing board 11, a lower board 12, a moving seat 13, and an upper board 14. The transmission device 18 includes a handle 15, a link 16, and two eccentric cams 17.

The pushing board 11 has two guide shafts 111, a plurality of lower blocks 112, and a plurality of upper blocks 113. The guide shafts 111 are respectively located on two sides of the pushing board 11. The lower blocks 112 are located on a lower surface of the pushing board 11. The upper blocks 113 are located on an upper surface of the pushing board 11.

The lower board 12 is located below the pushing board 11 for the pushing board 11 to slide on the upper surface thereof. The lower board 12 is a fixed element, and has two grooves 121 and a plurality of fixing combs 122. The grooves 121 are respectively located on two sides of the lower board to allow the lower block 112 of the pushing board 11 to slide therein. Due to the limitation of the grooves 121, the pushing board 11 can only move linearly to and fro. The fixing combs 122 are located at the front end of the lower board 12 and vertical to the lower board 12.

The moving seat 13 is located above the pushing board 11 in order to slide on the upper surface of the pushing board 11. The moving seat 13 has a plurality of shifting rods 131 and a plurality of slanted slots 132. The shifting rods 131 are located at the front end of the moving seat 13, and are positioned at a slanted angle towards the moving seat 13. The slanted slots 132 are used to accommodate the upper block 113 of the pushing board 11, such that when the pushing board 11 moves to and fro, it can guide the moving seat 13 to move laterally and back and forth.

The upper board 14 is a fixed element and is located above the moving seat 13. The upper board 14 has a plurality of slot apertures 141 for the fixing combs 122 and the shifting rods 131 to pass through, and the shifting rods 131 are movable in the slot apertures 141.

One end of the handle 15 is used to receive an external force, and the other end is secured to the link 16. Two ends of the link 16 are respectively secured to an eccentric cam 17. Each of the eccentric cams 17 has a guide slot 171. The guide slots 171 are respectively associated with the guide shaft 111 of the pushing board 11, so that when eccentric cams 17 rotate, they can drive the pushing board 11.

FIG. 4 shows a schematic view of the actuation of the conventional first-type binding mechanism. First, the plastic comb 2 is placed on the upper board 14, and the fixing combs 122 press against it. Then, an external force is exerted on the handle 15, so as to drive the link 16 and the eccentric cams 17. The rotation of the eccentric cams 17 drives the pushing board 11 to move backward, thus driving the moving seat 13 to move rightward, such that the shifting rods 131 also move rightward to enter the plastic comb 2. Then, the pushing board 11 moves backward continuously to drive the moving seat 13 to move backward, such that the shifting rods 131 also move backward to pull the plastic comb 2.

The first-type binding mechanism 1 of the conventional punch/binding machine for loose-leaf papers has the following disadvantages. The binding module 10 is formed by stacking four plates, thus having more components and being inconvenient to assemble. In addition, the moving seat 13 moves laterally and back and forth, thus having a large resistance and being easily worn.

FIG. 5 shows a schematic view of the actuation of a second-type binding mechanism of a conventional punch/binding machine for loose-leaf papers disclosed in U.S. Pat. No. 5,211,522. The conventional second-type binding mechanism 3 is used to clamp a wire comb 5 (FIG. 6). The conventional second-type binding mechanism 3 includes an upper clamping block 31 and a lower clamping block 32. The upper clamping block 31 and the lower clamping block 32 are L-shaped plates. After paper sheets 4 are placed in the wire comb 5, the paper sheets 4 and the wire comb 5 are placed together in the space between the upper clamping block 31 and the lower clamping block 32. Finally, another transmission device (not shown) is used to drive the upper clamping block 31 to move downward to clamp the wire comb 5.

In the conventional punch/binding machine for loose-leaf papers, the conventional first-type binding mechanism 1 and the conventional second-type binding mechanism 3 are two different mechanisms respectively. Since they are driven by different transmission devices, the two mechanisms require large spaces, and have a large number of components.

Moreover, a third-type binding method for loose-leaf papers utilizes a plastic coil 6 (FIG. 7). In the conventional method, the plastic coil 6 is rotated directly by a finger, so that the plastic coil 6 is spirally rolled into the holes of the loose-leaf papers. The method has the disadvantage of inconvenient operation.

Therefore, it is necessary to provide a punch/binding machine and a binding module thereof to solve the above problems.

### SUMMARY OF THE INVENTION

The present invention provides a punch/binding machine, which comprises a transmission device, a body, and a binding module. The transmission device receives an external force. The body is used to support the transmission device. The binding module comprises a fixing rod, a fixed comb plate, an upper board, a guide element, a moving seat, and a lower board. Two ends of the fixing rod are fixed on the body. The fixed comb plate has a plurality of fixing combs, and each of the fixing combs has a flute. The fixed comb plate is fixed on the fixing rod. The upper board has a plurality of slot apertures for the fixing combs to pass through, and the upper board is fixed on the fixing rod. The guide element is located on one side of the upper board in order to push a plastic comb in the flutes of the fixing combs. The moving seat has a plurality of shifting rods. The moving seat is located below the upper board, such that the shifting rods pass through the slot apertures of the upper board and pull the plastic comb. At least one end of the moving seat is connected to the transmission device, so as to be driven by the transmission device to move linearly to and fro. The lower board is located below the moving seat for providing the moving seat to slide on the surface thereof, and the lower board is fixed on the fixing rod.

The present invention has the following advantages. The binding module is formed by stacking three plates, i.e., the upper board, the moving seat, and the lower board, thus having a small number of components and being easily assembled. In addition, the moving seat only moves back and forth, thus having less resistance, and it cannot be easily worn out. Furthermore, the binding module has three types of binding functions simultaneously, and only one transmission device, i.e., the transmission device, is required to achieve the driving function, thus requiring a smaller space.

### BRIEF DESCRIPTION OF THE DRAWINGS

FIG. 1 is a schematic assembly view of a conventional first-type binding mechanism of a punch/binding machine for loose-leaf papers disclosed in U.S. Pat. No. 5,211,522;

FIG. 2 is a schematic exploded view of a conventional first-type binding mechanism of a punch/binding machine for loose-leaf papers disclosed in U.S. Pat. No. 5,211,522;

FIG. 3 is a perspective view of a conventional plastic comb;

FIG. 4 is a schematic view of the actuation of the conventional first-type binding mechanism of FIG. 1;

FIG. 5 is a schematic view of the actuation of a conventional second-type binding mechanism of a punch/binding machine for loose-leaf papers disclosed in U.S. Pat. No. 5,211,522;

FIG. 6 is a perspective view of a conventional wire comb;

FIG. 7 is a perspective view of a conventional plastic coil;

FIG. 8 is a perspective view of a punch/binding machine according to the present invention;

FIG. 9 is an exploded perspective view of a binding mechanism of a punch/binding machine according to the present invention;

FIG. 10 is a schematic view of the actuation of a first-type binding function of the binding mechanism according to the present invention;

FIG. 11 is a schematic view of the actuation of a second-type binding function of the binding mechanism according to the present invention;

FIG. 12 is a front view of the fixed comb plate of the bonding mechanism according to a second implementing aspect of the present invention;

FIG. 13 is a schematic side view of the fixed comb plate of the bonding mechanism according to a third implementing aspect of the present invention; and

FIG. 14 is a schematic top view of the fixed comb plate of the bonding mechanism according to the third implementing aspect of the present invention.

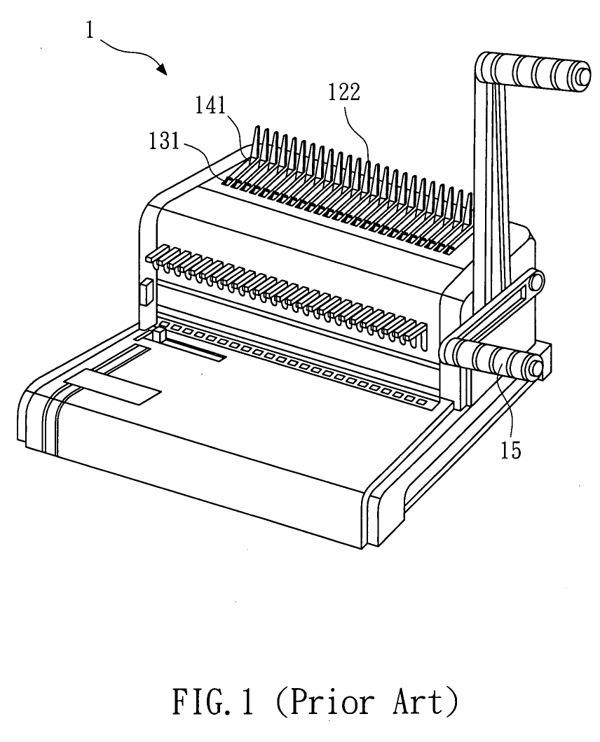

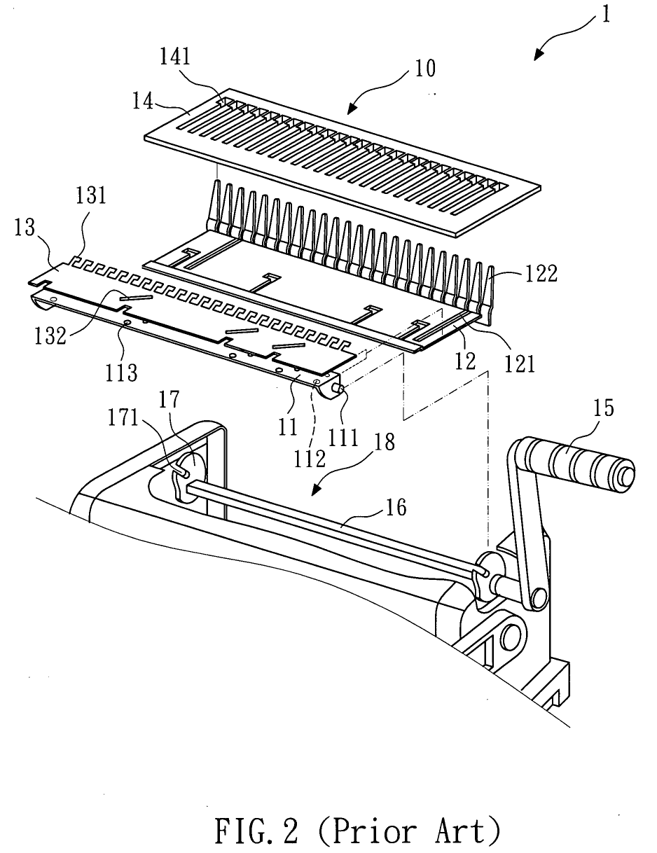

### DETAILED DESCRIPTION OF THE INVENTION

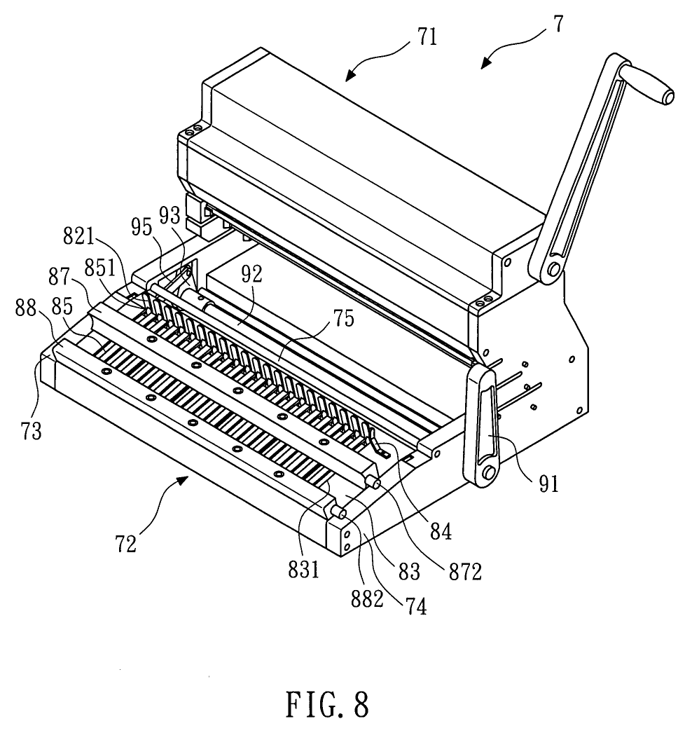

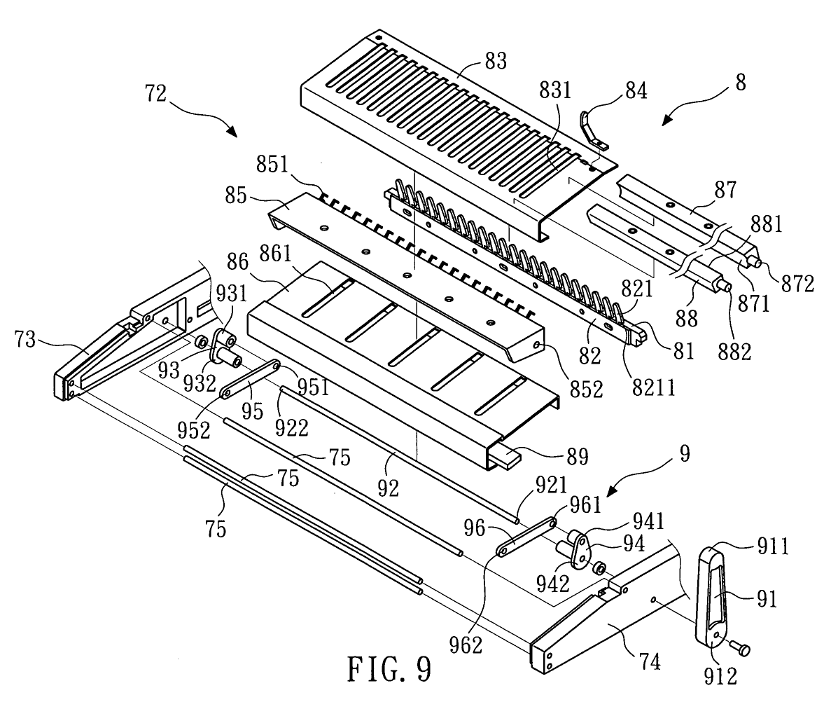

FIG. 8 shows a perspective view of a punch/binding machine according to the present invention. The punch/binding machine 7 of the present invention includes a punching mechanism 71 and a binding mechanism 72. FIG. 9 shows an exploded perspective view of a binding mechanism of the punch/binding machine according to the present invention. The binding mechanism 72 of the punch/binding machine 7 includes a body (including a left-side body 73 and a right-side body 74), a binding module 8, and a transmission device 9.

The left-side body 73 and the right-side body 74 are the housing of the binding mechanism 72, in which a plurality of positioning rods 75 is used to position and form an accommodation space to accommodate or support the binding module 8 and the transmission device 9.

The binding module 8 includes a fixing rod 81, a fixed comb plate 82, an upper board 83, a guide element 84, a moving seat 85, and a lower board 86. Two ends of the fixing rod 81 are respectively fixed on the left-side body 73 and the right-side body 74. The fixing rod 81 is a fixed element.

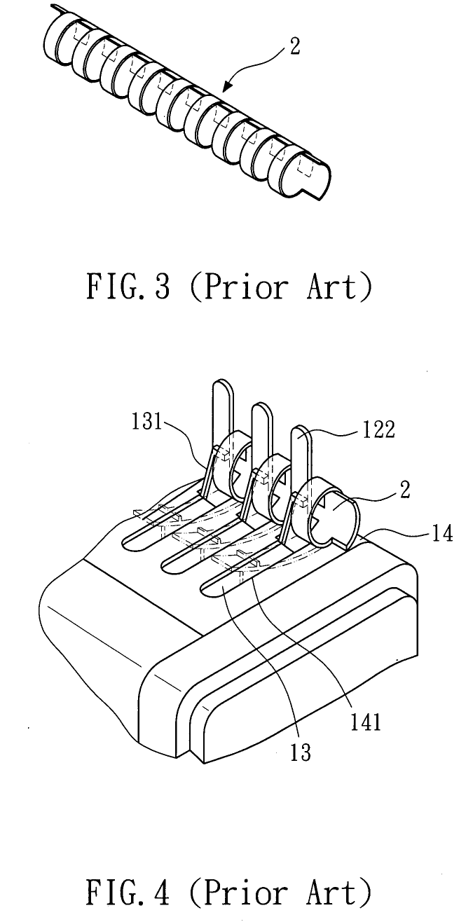

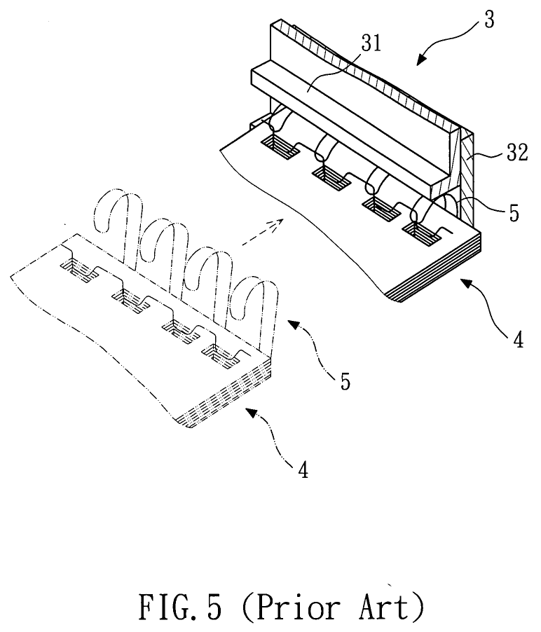

The fixed comb plate 82 has a plurality of fixing combs 821 and screw holes, and each of the fixing combs 821 has a flute 8211. The fixed comb plate 82 is disposed between the fixing rod 81 and the moving seat 85, which is a fixed element or a movable element. In this embodiment, the fixed comb plate 82 is fixed on the fixing rod 81 with a plurality of screws, that is, the fixed comb plate 82 is fixed on the body of the punch/binding machine 7 through the fixing rod 81, and thus, in this embodiment, the fixed comb plate 82 is a fixed element. The upper board 83 has a plurality of slot apertures 831 for the fixing combs 821 to pass through. The upper board 83 is fixed on the fixing rod 81, and the fixing rod 81 is located on the front end of the lower surface of the upper board 83, that is, the upper board 83 is fixed on the body of the punch/binding machine 7 through the fixing rod 81, and thus the upper board 83 is a fixed element. It can be understood that the upper board 83 can also be directly fixed on the body of the punch/binding machine 7. The guide element 84, e.g., a blade spring, is fixed on one side of the upper board 83 in order to push a plastic comb 2 (FIG. 3) into the flutes 8211 of the fixing combs 821.

It should be noted that in other embodiments, the fixing rod 81 and the fixed comb plate 82 can be omitted. The fixing comb 821 is directly fixed on one end of each of the slot apertures 831 of the upper board 83, and similarly, each fixing comb 821 has a flute 8211.

The moving seat 85 has a plurality of shifting rods 851 and two pivot portions 852. The shifting rods 851 are located on the front end of the moving seat 85, and the pivot portions 852 are respectively located on two ends of the moving seat 85. The moving seat 85 is located below the upper board 83, such that the shifting rods 851 pass through the slot apertures 831 of the upper board 83 and pull the plastic comb 2. The pivot portions 852 on two ends of the moving seat 85 are connected to the transmission device 9, so as to be driven by the transmission device 9 to move linearly to and fro.

The lower board 86 is located below the moving seat 85 for providing the moving seat 85 to slide on the surface thereof. The lower board 86 is fixed on the fixing rod 81, that is, the lower board 86 is fixed on the body of the punch/binding machine 7 through the fixing rod 81. The fixing rod 81 is located on the front end of the lower board 86. It is can be understood that the lower board 86 can also be directly fixed on the body of the punch/binding machine 7. Preferably, the lower board 86 further includes a plurality of guide slots 861.

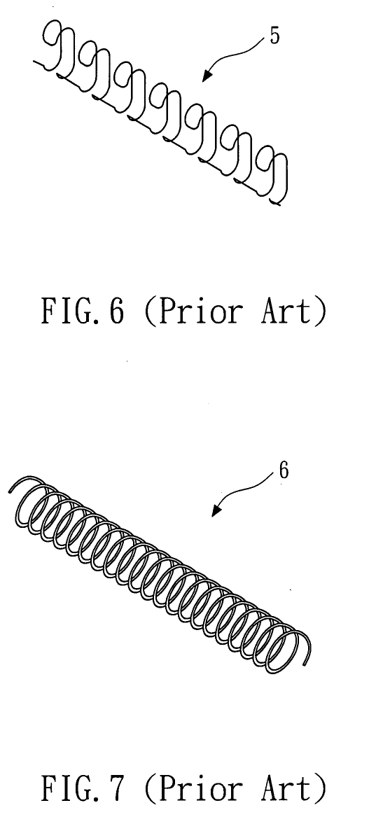

Preferably, the binding module 8 further includes a front clamping block 87 and a rear clamping block 88. The front clamping block 87 has a front arced surface 871, and the rear clamping block 88 has a rear arced surface 881. The front clamping block 87 and the rear clamping block 88 are used together to clamp a wire comb 5 (FIG. 6). The front clamping block 87 is fixed on the moving seat 85, and the rear clamping block 88 is fixed on the upper board 83. In this embodiment, a plurality of screws, i.e., a protruding structure, passes through the front clamping block 87, the slot apertures 831 of the upper board 83, the moving seat 85, and the guide slots 861 of the lower board 86 from top to bottom. A plurality of nuts lock the front clamping block 87 on the moving seat 85 from top to bottom, such that the front clamping block 87 moves along with the moving seat 85. The screws can move in the slot apertures 831 of the upper board 83 and the guide slots 861 of the lower board 86, so as to ensure the moving direction of the front clamping block 87 and the moving seat 85. It can be understood that in other applications, the lower surface of the moving seat 85 has a plurality of bumps, i.e., a protruding structure, and the bumps correspond to the guide slots 861 of the lower board 86 and move in the guide slots 861, thus also ensuring the moving direction of the moving seat 85. Moreover, in this embodiment, the rear clamping block 88 is also locked on the upper board 83 with a plurality of screws.

Preferably, the binding module 8 further includes a magnet 89 located below the lower board 86 and corresponding to the front clamping block 87 and the rear clamping block 88 for attracting the wire comb 5 (FIG. 6).

Preferably, the binding module 8 further includes a front roller 872 and a rear roller 882. The front roller 872 is located on one end of the front clamping block 87, and the rear roller 882 is located on one end of the rear clamping block 88. The front roller 872 and the rear roller 882 are used together to roll a plastic coil 6 (FIG. 7).

The transmission device 9 includes a handle 91, an input shaft 92, a left crank 93, a right crank 94, a left connecting lever 95, and a right connecting lever 96. The handle 91 is secured to the right crank 94, and two ends of the input shaft 92 are respectively secured to the left crank 93 and the right crank 94. The left crank 93 is pivoted to the left connecting lever 95, the right crank 94 is pivoted to the right connecting lever 96, and the left connecting lever 95 and the right connecting lever 96 are respectively pivoted to the pivot portion 852 on two sides of the moving seat 85.

In this embodiment, the handle 91 has a first end 911 and a second end 912. The input shaft 92 has a first end 921 and a second end 922. The left crank 93 has a first end 931 and a second end 932. The right crank 94 has a first end 941 and a second end 942. The left connecting lever 95 has a first end 951 and a second end 952. The right connecting lever 96 has a first end 961 and a second end 962. The first end 911 of the handle 91 is used to receive an external force. The second end 912 of the handle 91 is secured to the second end 942 of the right crank 94 through the right-side body 74. The second end 932 of the left crank 93 is pivoted to the left-side body 73. The first end 921 of the input shaft 92 is secured to the second end 942 of the right crank 94, and the second end 922 of the input shaft 92 is secured to the second end 932 of the left crank 93. The first end 941 of the right crank 94 is pivoted to the first end 961 of the right connecting lever 96, and the first end 931 of the left crank 93 is pivoted to the first end 951 of the left connecting lever 95. The second end 952 of the left connecting lever 95 is pivoted to the pivot portion (not shown) on the left end of the moving seat 85, and the second end 962 of the right connecting lever 96 is pivoted to the pivot portion 852 on the right end of the moving seat 85.

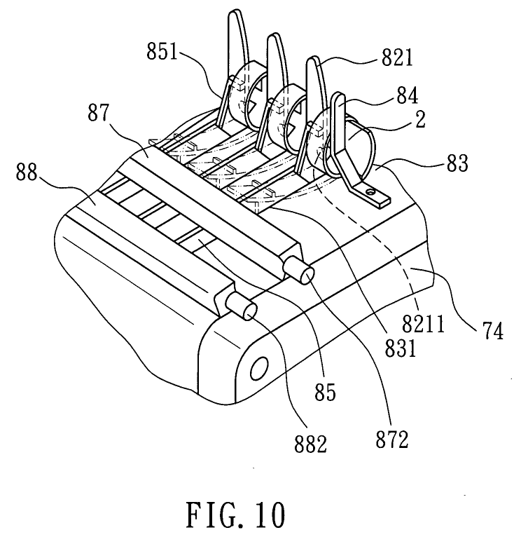

FIG. 10 shows a schematic view of the actuation of a first-type binding function of the binding mechanism according to the present invention. The first-type binding function of the present invention is used to pull a plastic comb 2, and the actuating manner is described as follows. First, the plastic comb 2 is placed on the upper board 83, and the fixing combs 821 press against it. Then, the guide element 84 pushes the plastic comb 2 leftward to enter the flutes 8211 of the fixing combs 821. Next, an external force is exerted on the first end 911 of the handle 91, so as to drive the second end 942 of the right crank 94, the second end 932 of the left crank 93, and the input shaft 92 to rotate. At this time, the right crank 94 and the left crank 93 respectively drive the right connecting lever 96 and the left connecting lever 95, so as to successively drive the moving seat 85 to move backward, such that the shifting rods 851 also move backward to pull the plastic comb 2.

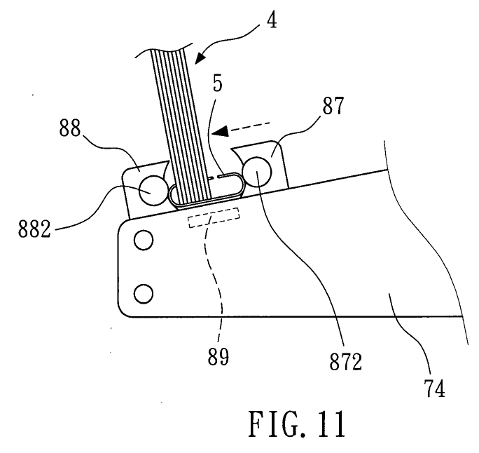

FIG. 11 shows a schematic view of the actuation of a second-type binding function of the binding mechanism according to the present invention. The second-type binding function of the present invention is used to clamp a wire comb 5, and the actuating manner is described as follows. First, the wire comb 5 is placed in the interval between the front clamping block 87 and the rear clamping block 88, so as to be attracted by the magnet 89. Then, the papers 4 are placed in the wire comb 5. Finally, the transmission device 9 is used to drive the moving seat 85 and the front clamping block 87 to move backward to clamp the wire comb 5.

A third binding function of the binding mechanism of the present invention is rolling a plastic coil 6 (FIG. 7) into the holes of the papers, and the actuating manner is described as follows. First, the paper sheets 4 are placed in the interval between the front clamping block 87 and the rear clamping block 88. Then, the plastic coil 6 is placed between the front roller 872 of the front clamping block 87 and the rear roller 882 of the rear clamping block 88. Finally, the front roller 872 or the rear roller 882 is rolled manually or in another manner, thus spirally rolling the plastic coil 6 into the holes of the papers 4.

The present invention has the advantage that the binding module 8 is formed by stacking three plates i.e., the upper board 83, the moving seat 85, and the lower board 86, thus having a small number of components and being easily assembled. In addition, the moving seat 85 only moves back and forth, thus having less resistance, and it cannot be easily worn out. Furthermore, the binding module 8 has all three types of binding functions, and only one transmission device, i.e., the transmission device 9, is used to achieve the driving function, thus requiring a smaller space.

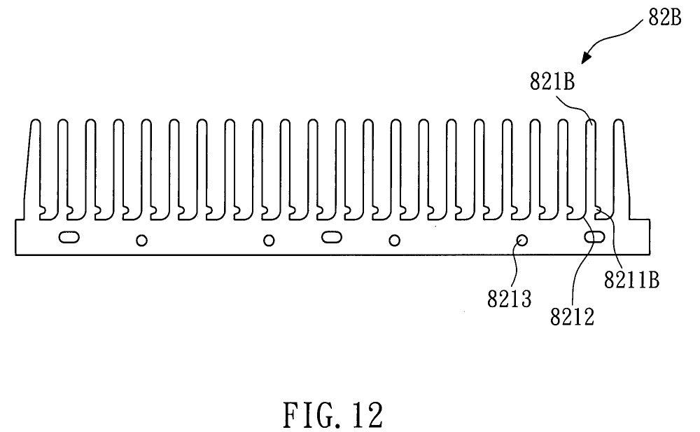

Referring to FIG. 12, a front view of the fixed comb plate of the bonding mechanism according to a second implementing aspect of the present invention is shown. The fixed comb plate 82B has a plurality of fixing combs 821B, and the upper end of fixing combs 821B has a uniform width. Each fixing comb 821B has a protruding portion 8211B and a guiding inclined portion 8212, and the protruding portions 8211B and the guiding inclined portions 8212 of the adjacent fixing combs 821B can be used to clamp the plastic comb 2. The fixed comb plate 82B further includes a plurality of screw holes 8213 for a plurality of screws passing through to be locked on the fixing rod 81.

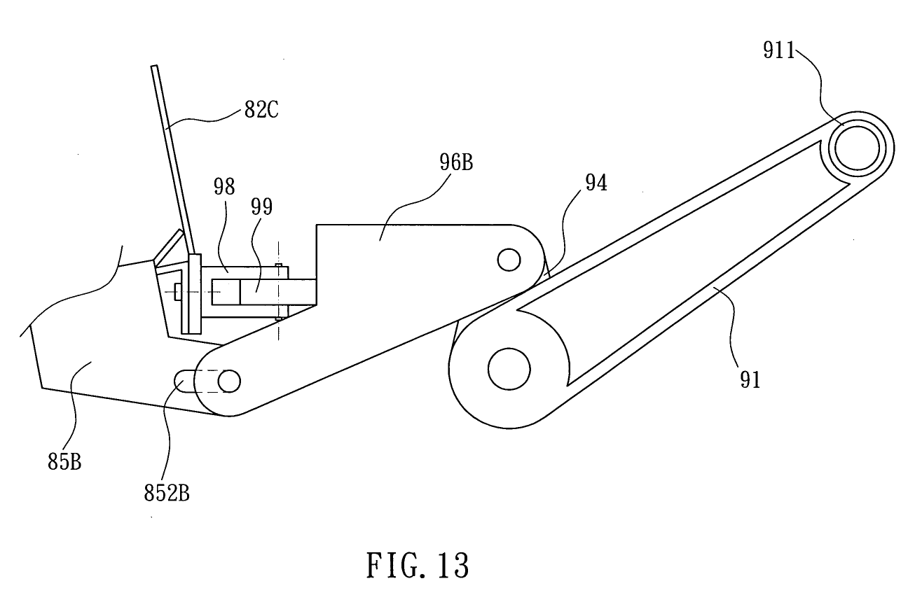

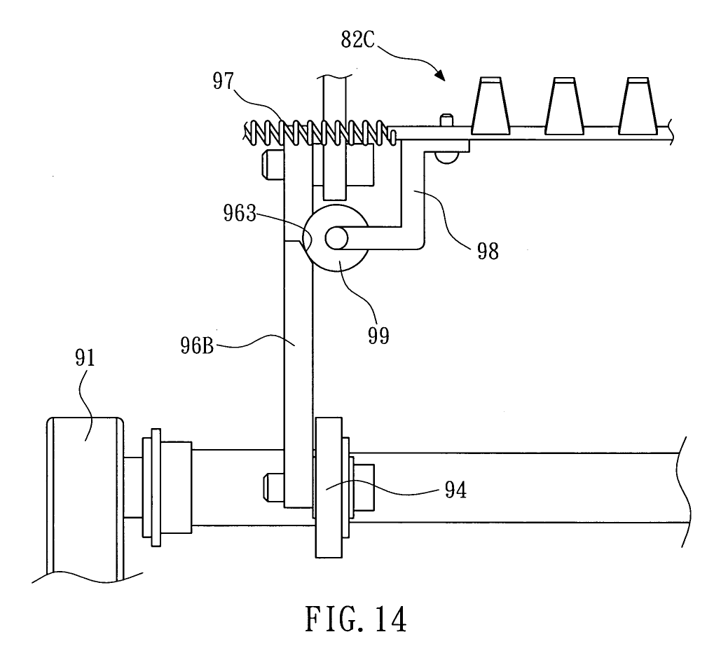

Referring to FIGS. 13 and 14, a schematic side view and a schematic top view of the fixed comb plate of the bonding mechanism according to a third implementing aspect of the present invention are respectively shown. In this implementing aspect, the fixed comb plate 82C is a movable element, and is substantially the same as the fixed comb plate 82 of FIG. 9 and FIG. 10, only except that the fixed comb plate 82C does not have screw holes but has a plurality of elongated guide slots. A plurality of pins passes through the fixing rod 81, the guide slots of the fixed comb plate 82C, and the moving seat 85. After being locked, the fixed comb plate 82C can move left and right. In order to match the fixed comb plate 82C, a pivot portion 852B of the moving seat 85B is designed to be an elongated guide slot, and the right connecting lever 96B has an inclined side edge 963. Moreover, one end of the fixed comb plate 82C is further connected to a spring 97, a roller bracket 98, and a roller 99. One end of the spring 97 is connected to the fixed comb plate 82C, and the other end is connected to the right-side body 74 (FIG. 9). One end of the roller bracket 98 is locked on the fixed comb plate 82C with screws, and the other end is connected to the roller 99. The roller 99 contacts the inclined side edge 963 of the right connecting lever 96B, and slides thereon.

The actuation of the fixed comb plate 82C is described as follows. An external force is applied onto the first end 911 of the handle 91, so as to drive the right crank 94 to rotate. At this time, the right crank 94 drives the right connecting lever 96B. As the pivot portion 852B of the moving seat 85B is an elongated guide slot, the right connecting lever 96B moves forward, such that the inclined side edge 963 of the right connecting lever 96B pushes the roller 99. Then, the roller 99 drives the roller bracket 98 and the fixed comb plate 82C to move to the right side of FIG. 13.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. A punch/binding machine, comprising:
a transmission device, for receiving an external force;
a body, for supporting the transmission device; and
a binding module, comprising:
a fixing rod, having two ends fixed on the body;
a fixed comb plate, having a plurality of fixing combs;
an upper board, having a plurality of slot apertures for the fixing combs to pass through, the upper board being fixed on the fixing rod;
a guide element, located on one side of the upper board, for pushing a plastic comb into the flutes of the fixing combs;
a moving seat, having a plurality of shifting rods, wherein the moving seat is located below the upper board, such that the shifting rods pass through the slot apertures of the upper board and pull the plastic comb, and at least one end of the moving seat is connected to the transmission device for driving the moving seat to move linearly to and fro; and
a lower board, located below the moving seat, for providing the moving seat to slide on the surface thereof, the lower board being fixed on the fixing rod.

2. The punch/binding machine as claimed in claim 1, wherein the body comprises a left-side body and a right-side body.

3. The punch/binding machine as claimed in claim 1, wherein the transmission device comprises a handle, an input shaft, a left crank, a right crank, a left connecting lever, and a right connecting lever; the handle is secured to the right crank, two ends of the input shaft are respectively secured to the left crank and the right crank, the left crank is pivoted to the left connecting lever, the right crank is pivoted to the right connecting lever, and the left connecting lever and the right connecting lever are respectively pivoted to two sides of the moving seat.

4. The punch/binding machine as claimed in claim 3, wherein the handle has a first end and a second end, the input shaft has a first end and a second end, the left crank has a first end and a second end, the right crank has a first end and a second end, the left connecting lever has a first end and a second end, the right connecting lever has a first end and a second end, the first end of the handle receives the external force, the second end of the handle is secured to the second end of the right crank via the body, the second end of the left crank is pivoted to the body, the first end of the input shaft is secured to the second end of the right crank, the second end of the input shaft is secured to the second end of the left crank, the first end of the right crank is pivoted to the first end of the right connecting lever, the first end of the left crank is pivoted to the first end of the left connecting lever, the second end of the left connecting lever is pivoted to the left end of the moving seat, and the second end of the right connecting lever is pivoted to the right end of the moving seat.

5. The punch/binding machine as claimed in claim 1, wherein the lower board further comprises a plurality of guide slots, the moving seat further comprises a plurality of protruding structures, and the protruding structures move in the guide slots, so as to ensure the moving direction of the moving seat.

6. The punch/binding machine as claimed in claim 1, further comprising a front clamping block and a rear clamping block, wherein the front clamping block is fixed on the moving seat, the rear clamping block is fixed on the upper board, the front clamping block has a front arced surface, the rear clamping block has a rear arced surface, and the front clamping block and the rear clamping block are used together to clamp a wire comb.

7. The punch/binding machine as claimed in claim 6, further comprising a magnet located below the lower board and corresponding to the front clamping block and the rear clamping block for attracting the wire comb.

8. The punch/binding machine as claimed in claim 6, further comprising a front roller and a rear roller, wherein the front roller is located on the front clamping block, the rear roller is located on the rear clamping block, and the front roller and the rear roller are used together to roll a plastic coil.

9. The punch/binding machine as claimed in claim 1, wherein the fixed comb plate is fixed on the fixing rod.

10. The punch/binding machine as claimed in claim 1, wherein the fixed comb plate is disposed between the fixing rod and the moving seat, and the fixed comb plate is movable.

11. A binding module for a punch/binding machine, comprising:
a fixing rod;
a fixed comb plate, having a plurality of fixing combs, each of the fixing combs having a flute, and the fixed comb plate being fixed on the fixing rod;
an upper board, having a plurality of slot apertures for the fixing combs to pass through, the upper board being fixed on the fixing rod;
a guide element, located on one side of the upper board, for pushing a plastic comb into the flutes of the fixing combs;
a moving seat, having a plurality of shifting rods, wherein the moving seat is located below the upper board, such that the shifting rods pass through the slot apertures of the upper board and pull the plastic comb, and at least one end of the moving seat is connected to a transmission device for driving the moving seat to move linearly to and fro; and
a lower board, located below the moving seat, for providing the moving seat to slide on the surface thereof, the lower board being fixed on the fixing rod.

12. The binding module as claimed in claim 11, wherein the transmission device comprises a handle, an input shaft, a left crank, a right crank, a left connecting lever, and a right connecting lever; the handle is secured to the right crank, two ends of the input shaft are respectively secured to the left crank and the right crank, the left crank is pivoted to the left connecting lever, the right crank is pivoted to the right connecting lever, and the left connecting lever and the right connecting lever are respectively pivoted to two sides of the moving seat.

13. The binding module as claimed in claim 12, wherein the handle has a first end and a second end, the input shaft has a first end and a second end, the left crank has a first end and a second end, the right crank has a first end and a second end, the left connecting lever has a first end and a second end, the right connecting lever has a first end and a second end, the first end of the handle receives the external force, the second end of the handle is secured to the second end of the right crank, the first end of the input shaft is secured to the second end of the right crank, the second end of the input shaft is secured to the second end of the left crank, the first end of the right crank is pivoted to the first end of the right connecting lever, the first end of the left crank is pivoted to the first end of the left connecting lever, the second end of the left connecting lever is pivoted to the left end of the moving seat, and the second end of the right connecting lever is pivoted to the right end of the moving seat.

14. The binding module as claimed in claim 11, wherein the lower board further comprises a plurality of guide slots, the moving seat further comprises a plurality of protruding structures, and the protruding structures move in the guide slots, so as to ensure the moving direction of the moving seat.

15. The binding module as claimed in claim 11, further comprising a front clamping block and a rear clamping block, wherein the front clamping block is fixed on the moving seat, the rear clamping block is fixed on the upper board, the front clamping block has a front arced surface, the rear clamping block has a rear arced surface, and the front clamping block and the rear clamping block are used together to clamp a wire comb.

16. The binding module as claimed in claim 15, further comprising a magnet located below the lower board and corresponding to the front clamping block and the rear clamping block for attracting the wire comb.

17. The binding module as claimed in claim 15, further comprising a front roller and a rear roller, wherein the front roller is located on the front clamping block, the rear roller is located on the rear clamping block, and the front roller and the rear roller are used together to roll a plastic coil.

18. The binding module as claimed in claim 11, wherein the fixed comb plate is fixed on the fixing rod.

19. The binding module as claimed in claim 11, wherein the fixed comb plate is disposed between the fixing rod and the moving seat, and the fixed comb plate is movable.

20. A binding module for a punch/binding machine, comprising:
an upper board, having a plurality of slot apertures, wherein a plurality of fixing combs are disposed on one end of each of the slot apertures respectively, and each of the fixing combs has a flute;
a guide element, located on one side of the upper board, for pushing a plastic comb into the flutes of the fixing combs;
a moving seat, having a plurality of shifting rods, wherein the moving seat is located below the upper board, such that the shifting rods pass through the slot apertures of the upper board and pull the plastic comb, and at least one end of the moving seat is connected to a transmission device for driving the moving seat to move linearly to and fro; and
a lower board, located below the moving seat, for providing the moving seat to slide on the surface thereof.

21. The binding module as claimed in claim 20, wherein the lower board further comprises a plurality of guide slots, the moving seat further comprises a plurality of protruding structures, and the protruding structures move in the guide slots, so as to ensure the moving direction of the moving seat.

22. The binding module as claimed in claim 20, wherein the upper board and the lower board are fixed on a body of the punch/binding machine.

23. The binding module as claimed in claim 20, wherein the fixing combs are fixed on a fixed comb plate, and the fixed comb plate is fixed on a body of the punch/binding machine.

24. The binding module as claimed in claim 20, further comprising a fixing rod, wherein the upper board and the lower board are fixed on the fixing rod.

25. The binding module as claimed in claim 20, further comprising a front clamping block and a rear clamping block, wherein the front clamping block is fixed on the moving seat, the rear clamping block is fixed on the upper board, the front clamping block has a front arced surface, the rear clamping block has a rear arced surface, and the front clamping block and the rear clamping block are used together to clamp a wire comb.

26. The binding module as claimed in claim 25, further comprising a magnet located below the lower board and corresponding to the front clamping block and the rear clamping block for attracting the wire comb.

27. The binding module as claimed in claim 20, further comprising a front roller and a rear roller, wherein the front roller is located on the front clamping block, the rear roller is located on the rear clamping block, and the front roller and the rear roller are used together to roll a plastic coil.

28. A punch/binding machine, comprising:
a transmission device, for receiving an external force;
a body, for supporting the transmission device; and
a binding module, comprising:
an upper board, having a plurality of slot apertures, wherein a plurality of fixing combs are disposed on one end of each of the slot apertures respectively, and each of the fixing combs has a flute;
a guide element, located on one side of the upper board, for pushing a plastic comb into the flutes of the fixing combs;
a moving seat, having a plurality of shifting rods, wherein the moving seat is located below the upper board, such that the shifting rods pass through the slot apertures of the upper board and pull the plastic comb, and at least one end of the moving seat is connected to the transmission device for driving the moving seat to move linearly to and fro; and
a lower board, located below the moving seat, for providing the moving seat to slide on the surface thereof.

29. The punch/binding machine as claimed in claim 28, wherein the lower board further comprises a plurality of guide slots, the moving seat further comprises a plurality of protruding structures, and the protruding structures move in the guide slots, so as to ensure the moving direction of the moving seat.

30. The punch/binding machine as claimed in claim 28, wherein the upper board and the lower board are fixed on the body.

31. The punch/binding machine as claimed in claim 28, wherein the fixing combs are fixed on a fixed comb plate, and the fixed comb plate is fixed on the body of the punch/binding machine.

32. The punch/binding machine as claimed in claim 28, wherein the binding module further comprises a fixing rod having two ends fixed on the body, and the upper board and the lower board are fixed on the fixing rod.

33. The punch/binding machine as claimed in claim 28, further comprising a front clamping block and a rear clamping block, wherein the front clamping block is fixed on the moving seat, the rear clamping block is fixed on the upper board, the front clamping block has a front arced surface, the rear clamping block has a rear arced surface, and the front clamping block and the rear clamping block are used together to clamp a wire comb.

34. The punch/binding machine as claimed in claim 33, further comprising a magnet located below the lower board and corresponding to the front clamping block and the rear clamping block for attracting the wire comb.

35. The punch/binding machine as claimed in claim 28, further comprising a front roller and a rear roller, wherein the front roller is located on the front clamping block, the rear roller is located on the rear clamping block, and the front roller and the rear roller are used together to roll a plastic coil.
